(19) United States
(12) Patent Application Publication
(10) Pub. No.: US 2020/0068818 A1
(43) Pub. Date: Mar. 5, 2020

(54) WATER-RETAINING LAYER FOR RETAINING WATER IN SOIL, GREENING SYSTEM AND CONSTRUCTION METHOD OF GREENING SYSTEM

(71) Applicant: SUMITOMO RUBBER INDUSTRIES, LTD., Kobe-shi, Hyogo (JP)

(72) Inventor: Kazuki NOJIRI, Kobe-shi, Hyogo (JP)

(73) Assignee: SUMITOMO RUBBER INDUSTRIES, LTD., Kobe-shi, Hyogo (JP)

(21) Appl. No.: 16/491,954

(22) PCT Filed: Jan. 30, 2018
(86) PCT No.: PCT/JP2018/002976

§ 371 Date: Sep. 6, 2019

(30) Foreign Application Priority Data
Mar. 9, 2017 (JP) 2017-044955

(51) Int. Cl. A01G 24/20; A01G 20/00; A01G 7/00; E02D 17/20; A01G 27/00

(52) U.S. Cl. CPC A01G 24/20; A01G 20/00; A01G 27/008; E02D 17/20; A01G 7/00

(57) ABSTRACT

The present invention provides a water-retaining layer for retaining water in soil, the water-retaining layer being composed of a coagulated natural rubber latex; a greening system having the water-retaining layer provided; and a construction method of the greening system, comprising: an exposing step of removing surface soil in a construction target land and exposing underground soil, a spraying step of spraying a natural rubber latex on an exposed surface of soil, a coagulation step of coagulating the natural rubber latex to form a water-retaining layer, and a covering step of covering the water-retaining layer with the removed surface soil.

### TECHNICAL FIELD

The present invention relates to a water-retaining layer for retaining water in soil, a greening system and a construction method of the greening system.

### BACKGROUND OF THE INVENTION

A method for covering a surface of soil with a film or a sheet (Patent Document 1), a method for covering a surface of soil with a mulching material having a water-retaining property (Patent Document 2) and the like have been hitherto proposed as a method for securing water necessary for growth of plants in soil. Further, a method for embedding a water-retaining material in soil (Patent Documents 3 and 4) has been also proposed.

### PRIOR ART DOCUMENTS

### Patent Documents

Patent Document 1: JP H8-172939 A

Patent Document 2: JP H11-243793 A

Patent Document 3: JP S56-11722 A

Patent Document 4: JP 2012-120485 A

### SUMMARY OF THE INVENTION

### Problem to be Solved by the Invention

However, in the method for securing water in the soil by covering the surface of the soil, although it is possible to suppress evaporation of water in the soil, it is not possible to inhibit the water from penetrating deeply in the soil in the case of sandy soil or the like as in a dry land, and there is a problem with low utilization efficiency of sprinkled water and rainwater.

In the method for embedding a water-retaining material or the like into the soil, water can be prevented from penetrating deeply into the soil, but there is a problem that environmental load is large, embedding is not easy, and cost is high.

Therefore, development of a water-retaining layer assuring a low environmental load and enabling easy construction thereof and a method for forming it is demanded.

### Means to Solve the Problem

The present invention relates to a water-retaining layer for retaining water in soil, the water-retaining layer being composed of a coagulated natural rubber latex.

It is preferable that the natural rubber latex is a high ammonia natural rubber latex.

It is preferable that the coagulated natural rubber latex comprises a coagulant.

The present invention relates to a greening system having the water-retaining layer provided underground in a depth of 3 to 300 cm from the surface of soil.

Further, the present invention relates to a construction method of the above-mentioned greening system, comprising:

an exposing step of removing surface soil in a construction target land and exposing underground soil,
a spraying step of spraying a natural rubber latex on an exposed surface of soil,
a coagulation step of coagulating the natural rubber latex to form a water-retaining layer, and
a covering step of covering the water-retaining layer with the removed surface soil.

### Effects of the Invention

According to the present invention, it is possible to provide a water-retaining layer for retaining water in soil, the water-retaining layer assuring a low environmental load and being constructed easily, a greening system comprising the water-retaining layer and a construction method of the greening system.

### MODE FOR CARRYING OUT THE INVENTION

### Water-Retaining Layer

Water-retaining layer for retaining water in soil according to one embodiment of the present invention is characterized in that it is composed of a coagulated natural rubber latex.

A main component of the natural rubber latex is a cis-1,4-isoprene, which is hydrophobic. Therefore, by forming a film of the natural rubber latex in the soil, rainwater or the like which has percolated through the soil from the ground surface can be blocked, and it is possible to store water in the soil on the film top. Also, when a natural rubber latex is used, unlike the case of laying or embedding a sheet such as a vinyl chloride sheet in the soil, the natural rubber latex is decomposed in the soil, and recovery and disposal thereof is not required. Therefore, it is possible to reduce the environmental load.

Examples of a usable natural rubber latex include raw latexes (field latexes) extracted from rubber producing plants, or concentrated natural rubber latexes concentrated by, for example, removal of protein by a known concentration method such as centrifugation from field latexes or the like. Examples of the concentrated natural rubber latex include a high ammonia natural rubber latex formulated by mainly blending ammonia as a preservative, a low ammonia natural rubber latex blended with lauric acid and boric acid other than ammonia and the like. Among these, a high ammonia natural rubber latex is preferred because of low cost and because it does not contain chemicals.

Because usually a latex is subject to bacteria proliferation and is coagulated with time, ammonia is added as a bacteria breeding inhibitor. However, in many cases, tetramethylthiuram disulfide (TMTD) or zinc oxide is added to a low ammonia natural rubber latex in place of ammonia. It is known that TMTD is largely harmful due to irritation to the skin and eyes, allergic action on skin, mutagenicity against microorganisms, induction of chromosomal abnormalities to mammalian cells and the like, and that zinc oxide also has aquatic environmental toxicity. In the present embodiment, by using a high ammonia natural rubber latex, it is possible to prevent outflow of the harmful substances into natural environment, and environmental load can be reduced.

The water-retaining layer is composed of a coagulated natural rubber latex. A method for coagulating an un-coagulated natural rubber latex is not particularly limited, and there are, for example, a method of coagulating a natural rubber latex by natural drying or drying by heating, and a method of coagulating a natural rubber latex by adding a coagulant to the un-coagulated natural rubber latex.

Examples of the coagulant include inorganic acids such as hydrochloric acid, nitric acid, phosphoric acid and sulfuric acid; organic acids such as formic acid, acetic acid, lactic acid, oxalic acid, malic acid, tartaric acid, succinic acid, fumaric acid, maleic acid, citric acid, ascorbic acid, gluconic acid and glucuronic acid; salts of these acids; and flocculants such as anionic polymer flocculants, cationic polymer flocculants and nonionic polymer flocculants, and the organic acids are suitably used from the viewpoint of cost and ease of use. The coagulant dissolved or suspended in a solvent can be used, and example of such a solvent includes water.

Examples of the organic acid suitably used include those having high solubility in water and good degradability and assuring small health hazard of the user and low environmental load. Examples of such organic acids include hydroxy acids having 3 to 7 carbon atoms such as lactic acid, malic acid, tartaric acid and citric acid, and citric acid is preferred. Moreover, a neutralizing effect of ammonia derived from a high ammonia natural rubber latex and these organic acids can reduce the environmental load, and harmfulness of ammonium salts of these organic acids produced by the neutralization reaction is low.

The water-retaining layer may be a layer (sheet-like layer) consisting of a coagulated natural rubber latex or may be a layer of a coagulated natural rubber latex containing soil components therein. Here, “a layer containing soil components” means a layer, in which a natural rubber latex penetrates into the gaps between the soil components and is in a coagulated state, and the layer is composed of the natural rubber latex and soil components in a state of a sea-island structure comprising a sea structure composed of the coagulated natural rubber latex and an island structure of the soil components.

### Layer Containing Soil Components

The layer containing soil components can be formed by a method of spraying an un-coagulated natural rubber latex onto the underground soil exposed by removing the surface soil and then coagulating the latex, a method of spraying a mixture of an un-coagulated natural rubber latex and previously collected soil onto the exposed underground soil and coagulating the mixture or the like method. It is preferable to embed the layer containing soil components underground in a depth of 3 cm or more from the surface of soil in a construction target land since it is possible to prevent water from penetrating deeply into soil.

The layer containing soil components can store water absorbed in the gap or the like between the coagulated natural rubber latex and the soil components. Since the absorbed water is supplied into the soil gradually, it is possible to secure the water in the soil more. Further, a thickness and a density of the layer containing soil components can be adjusted by the amount and concentration of the natural rubber latex, thereby making it possible to leak water moderately. By leaking water moderately, it is possible to suppress problems with root rot and abnormal breeding of bacteria due to accumulation of sprinkled water or rainwater on the water-retaining layer.

The layer thickness in the case of the layer containing soil components is preferably not less than 0.3 mm, more preferably not less than 1.0 mm, further preferably not less than 1.5 mm, particularly preferably not less than 10 mm for the reason of ensuring an amount of water to be absorbed and stored. Although from the viewpoint of ensuring the water, it is preferable that the layer thickness is as large as possible, when the layer becomes too thick, an amount of natural rubber latex increases, thereby resulting in high cost. Therefore, the layer thickness is preferably not more than 300 mm, more preferably not more than 100 mm.

An amount of natural rubber latex in the case of the layer containing soil components is appropriately adjusted according to kind of plant to be cultivated, and for the reason of ensuring an amount of water to be absorbed and stored, is preferably 300 g/m² or more, more preferably 500 g/m² or more. Further, the amount of natural rubber latex is preferably 27,300 g/m² (an amount of 1/10 assuming the sheet-like layer thickness to be 300 mm) or less, more preferably 9,100 g/m² (assuming the sheet-like layer thickness to be 100 mm) or less from the viewpoint of a material cost.

In the case of the layer containing soil components, the coagulant dissolved or suspended in a solvent is used preferably. By spraying after dissolving or suspending the coagulant in a solvent, the coagulant can be uniformly sprayed on the entire ground surface, and the thickness of the water-retaining layer can be made uniform. A concentration of the coagulant in such a case will vary depending on kind of the coagulant. When the concentration is too low, there is a drawback that because coagulation of the natural rubber latex is too slow, it may not be possible to form a layer, and when the concentration is too high, there is a drawback that coagulation of the natural rubber latex starts quickly, and a layer containing soil components may be hardly formed. Those skilled in the art, considering such viewpoints, can set an appropriate concentration according to kind of the coagulant. Generally, the concentration of the coagulant is preferably within the range of 4.0 to 30.0% by mass. For example, when an organic acid (preferably hydroxy acid having 3 to 7 carbon atoms) is used as a coagulant and is used as an aqueous solution, the concentration of the aqueous solution of organic acid is preferably not less than 4.0% by mass, more preferably not less than 5.0% by mass, further preferably not less than 7.0% by mass, particularly preferably not less than 9.0% by mass. On the other hand, the concentration of the aqueous solution of organic acid is preferably not more than 30.0% by mass, more preferably not more than 20.0% by mass, further preferably not more than 18.0% by mass, particularly preferably not more than 15.0% by mass.

In the case of the layer containing soil components, when the coagulant dissolved or suspended in a solvent is used, an amount of a solution of the coagulant to an amount of natural rubber latex (an amount of a solution of the coagulant/an amount of natural rubber latex) will vary depending on kind of the coagulant, the concentration of the solution of the coagulant, etc. When the amount of a solution of the coagulant is small, there is a drawback that coagulation of the natural rubber latex does not proceed and a layer containing soil cannot be formed. When the amount of a solution of the coagulant is large, there is a drawback that the whole surface of the natural rubber latex will be rapidly coagulated, resulting in a continuous sheet-like layer. Those skilled in the art, considering such viewpoints, can set an appropriate amount according to kind of the coagulant. For example, when an aqueous solution of organic acid (preferably an aqueous solution of hydroxy acid having 3 to 7 carbon atoms) is used as a solution of the coagulant, an amount of a solution of the coagulant to an amount of natural rubber latex (an amount of a solution of the coagulant/an amount of natural rubber latex) is preferably 0.3 or more, more preferably 0.4 or more, further preferably 0.5 or more. On the other hand, the amount of a solution of the coagulant to the amount of natural rubber latex use (amount of a solution of the coagulant/amount of natural rubber latex) is preferably 2.0 or less, more preferably 1.0 or less, further preferably 0.8 or less, particularly 0.55 or less.

### Sheet-Like Layer

A sheet-like layer can be prepared by a method of drying an un-coagulated natural rubber latex thinly spread on a flat plate or coagulation by adding a coagulant, a method of thinly spreading a natural rubber latex comprising a coagulant having been added thereto previously or the like method. It is preferable to embed the sheet-like layer underground in a depth of 3 cm or more from the surface of soil in a construction target land.

The layer thickness of the sheet-like layer is preferably 0.1 mm or more, more preferably 0.3 mm or more, further preferably 0.5 mm or more, further preferably 0.7 mm or more, further preferably 0.9 mm or more, further preferably 1 mm or more since the latex layer may be torn when a force is applied to the soil on the layer and the layer is displaced. Further, from the viewpoint of a material cost, the layer thickness is preferably 30 mm or less, more preferably 25 mm or less, further preferably 20 mm or less, further preferably 17 mm or less, further preferably 15 mm or less.

In the case of the sheet-like layer, an amount of natural rubber latex is preferably 90 g/m² or more, more preferably 900 g/m² or more since the latex layer may be torn when a force is applied to the soil on the layer and the layer is displaced. Further, from the viewpoint of a material cost, the amount of natural rubber latex is preferably 27,500 g/m² or less, more preferably 13,700 g/m² or less.

In the case of the sheet-like layer, when the coagulant dissolved or suspended in a solvent is used, a concentration thereof will vary depending on kind of the coagulant. When the concentration is too low, there is a drawback that a natural rubber latex is not coagulated and the layer may not be formed, and when the concentration is too high, there is a drawback that an amount of the coagulant that are required for spraying the coagulant on the entire surface of the sprayed latex increases, resulting in high cost. Those skilled in the art, considering such viewpoints, can set an appropriate concentration according to kind of the coagulant. In general, the concentration of the coagulant is preferably not less than 10% by mass, more preferably not less than 20% by mass. On the other hand, the concentration is preferably not more than 60% by mass, more preferably not more than 40% by mass.

In the case of the sheet-like layer, when using the coagulant dissolved or suspended in a solvent, an amount of a solution of the coagulant to an amount of natural rubber latex (an amount of a solution of the coagulant/an amount of natural rubber latex) will vary with kind, concentration or the like of the coagulant in the solution of the coagulant. When the amount of solution of the coagulant to be sprayed to the latex surface is small, there is a drawback that the entire surface of the natural rubber latex does not coagulate and a discontinuous sheet is obtained, thus making it impossible to form a continuous sheet-like layer. When the amount of the solution of the coagulant is too large, there is a drawback that an amount of active ingredient in the solution of the coagulant increases, resulting in high cost. Those skilled in the art, considering such viewpoints, can set an appropriate amount according to kind of the coagulant. An amount of a solution of the coagulant to an amount of natural rubber latex (amount of a solution of the coagulant/amount of natural rubber latex) is usually preferably 0.6 or more, more preferably 0.8 or more. On the other hand, the amount of solution of the coagulant to the amount of natural rubber latex (amount of a solution of the coagulant/amount of natural rubber latex) is preferably 2.0 or less, more preferably 1.5 or less, further preferably 1.0 or less.

### Greening System

A greening system according to one embodiment of the present invention is characterized in that the above-mentioned water-retaining layer is embedded underground. According to this greening system, since it has the water-retaining layer composed of a natural rubber latex in the ground, it is possible to prevent sprinkled water or rainwater from penetrating deeply into soil to ensure water in the soil. Therefore, by setting plants on the water-retaining layer, it is possible to ensure the water necessary for the growth of plants. In particular, in areas where soil components are sandy and in areas where plants are hardly grown due to lack of rain, an environment where plants are viable can be developed by using the greening system.

The above-mentioned water-retaining layer may be formed into the layer containing soil components described above or a sheet-like layer. Among them, the layer containing soil components is preferable for the reason that water in soil can be secured more, and the construction is easy.

Depth from the surface of soil for applying the water-retaining layer may be appropriately adjusted depending on plants or the like to be cultivated, and is preferably 3 to 300 cm. If the depth is less than 3 cm, soil is insufficient to secure water for growth of a plant. In addition, when the depth is more than 300 cm, construction tends to be difficult. It is noted that plants cultivated by using the greening system is not limited particularly.

A method of cultivating a plant is also not limited particularly, and the plant can be cultivated in a conventional manner.

Further, the greening system may comprise devices provided on a normal greening system, for example, a sprinkler and the like in addition to the above-mentioned water-retaining layer.

### Construction Method

In the construction of the greening system, it is preferable that the water-retaining layer is a layer containing soil components. If the water-retaining layer is a layer containing soil components, unlike a case of stretching a heavy load such as a sheet, a solution or suspension of a natural rubber latex and coagulant can be sprayed with a pesticide sprayer used generally, and therefore, neither special equipment nor heavy machinery is needed, thus making it possible to easily construct in remote areas such as dry land and the like.

Example of a construction method when the water-retaining layer of the greening system is a layer containing soil components includes a construction method of a greening system, comprising an exposing step of removing surface soil in a construction target land and exposing underground soil; a spraying step of spraying a natural rubber latex onto the exposed surface of soil; a coagulation step of coagulating the natural rubber latex to form a water-retaining layer; and a covering step of covering the water-retaining layer with the removed surface soil.

The exposing step is a step of removing the surface soil in the construction target land up to a depth where the water-retaining layer is provided and then exposing underground soil. A method of removing the surface soil is not limited particularly, and a conventional method can be employed depending on a depth and area.

The spraying step is a step of spraying an un-coagulated natural rubber latex onto the exposed surface of soil, and it is possible to adjust a layer thickness by a spraying amount, the concentration of the natural rubber latex and a period of time required until the step is shifted to the coagulation step. A spraying means is not limited particularly but includes can be appropriately selected according to an area and terrain of the ground in the construction target land. Spraying may be carried out, for example, with a small spraying unit such as a watering pot or a sprayer, or may be carried out by a hydro-seeder, a helicopter or the like.

The coagulation step is a step of forming the water-retaining layer by coagulating the sprayed natural rubber latex. Examples of a coagulating method include a method of coagulating by drying through natural drying, heating or the like and a method of coagulating by adding a coagulant to the un-coagulated natural rubber latex. In the case of coagulation using the coagulant, the coagulant dissolved or suspended in a solvent can be used, and in that case, kind and concentration of the coagulant are as described above. Further, it is preferable to spray the coagulant by the spraying method as mentioned in the spraying step. The thickness of the water-retaining layer can be adjusted also by the amount and concentration of the coagulant.

The covering step is a step of covering the removed surface soil onto the water-retaining layer. The covering method is not limited particularly, and a conventional method can be employed, depending on an amount and area of the surface soil. When performing the covering step, the coagulation state of the water-retaining layer is not limited particularly, and the covering step may be performed during the coagulation.

Incidentally, if the layer containing the soil components is intended to be formed by the method of scattering a mixture of the previously collected soil and the un-coagulated natural rubber latex onto the exposed underground soil and coagulating it, the above-mentioned spraying step may be replaced by a step of scattering a mixture of the previously collected soil and the natural rubber latex onto the exposed underground soil.

Further, when the water-retaining layer of the greening system is a sheet-like layer, examples of the construction method include a construction method of a greening system comprising an exposing step of removing surface soil in the construction target land and exposing the underground soil, a laying step of laying a previously prepared sheet-like water-retaining layer on the exposed surface of soil and a covering step of covering the water retaining layer with the removed surface soil.

The exposing step and the covering step may be the same steps as in the case of the layer containing the soil components.

The laying step is a step of laying, on the exposed surface of soil, a sheet-like natural rubber latex prepared by a method of drying an un-coagulated natural rubber latex thinly spread on a flat plate or coagulating the un-coagulated natural rubber latex by adding a coagulant thereto or a method of thinly spreading a natural rubber latex to which a coagulant has been added previously. Incidentally, a laying method is not limited particularly, and can be carried out by a conventional method.

Among these construction methods, since the construction can be performed easily in a short period of time, preferred is the construction method comprising an exposing step of removing surface soil in a construction target land and exposing underground soil; a spraying step of spraying a natural rubber latex onto the exposed surface of soil; a coagulation step of coagulating the natural rubber latex to form a water-retaining layer; and a covering step of covering the water-retaining layer with the removed surface soil.

As described above, in the present embodiment, there are provided, for example, the following [1] to [15] and the like.

[1] A water-retaining layer for retaining water in soil, the water-retaining layer being composed of a coagulated natural rubber latex.

[2] The water-retaining layer of above [1], where the natural rubber latex is high ammonia natural rubber latex.

[3] The water-retaining layer of the above [1] or [2], where the coagulated natural rubber latex comprises a coagulant.

[4] A greening system having a water-retaining layer of any one of the above [1] to [3] provided underground in a depth of 3 to 300 cm from a surface of soil.

[5] A construction method of the greening system of the above [4], comprising: an exposing step of removing surface soil in a construction target land and exposing underground soil, a spraying step of spraying a natural rubber latex on a surface of the exposed soil, a coagulation step of coagulating the natural rubber latex to form a water-retaining layer, and a covering step of covering the water-retaining layer with the removed surface soil.

[6] A forming method for forming a water-retaining layer for retaining water in soil, the method comprising a step of spraying an un-coagulated natural rubber latex onto target soil and coagulating the un-coagulated natural rubber latex.

[7] The forming method of the above [6], where a thickness of the water-retaining layer is 0.3 mm or more.

[8] The forming method of the above [6] or [7], where an amount of natural rubber latex is 300 g/m² or more.

[9] The forming method of any one of the above [6] to [8], which is characterized in that the un-coagulated natural rubber latex is coagulated by spraying a coagulant.

[10] The forming method of the above [9], where the coagulant is an organic acid.

[11] The forming method of the above [9] or [10], where when the coagulant is dissolved or suspended in a solvent and is sprayed, a concentration of the coagulant is 4.0 to 30.0% by mass.

[12] The forming method of any one of the above [9] to [11], wherein an amount of a solution of the coagulant to an amount of natural rubber latex (amount of a solution of the coagulant/amount of natural rubber latex) is from 0.3 to 2.0.

[13] A water-retaining layer for retaining water in soil, which is formed by the forming method of any one of the above [6] to [12].

[14] A greening system having the water-retaining layer of the above [13] provided underground in a depth of 3 to 300 cm from a surface of soil.

[15] A method of constructing a greening system, comprising a covering step of covering surface soil in a depth of 3 to 300 cm on the water-retaining layer formed by the forming method of any one of the above [6] to [12].

### Example

The present invention is described with reference to Examples, but the invention is not limited only to the examples.

An acrylic bottom base plate having 30 holes with a diameter of 5 mm was fixed to a lower end of a transparent acrylic pipe having an outer diameter of 100 mm, an inner diameter of 90 mm and a length of 550 mm with a 200 mesh nylon mesh being sandwiched between the lower end of the pipe and the acrylic plate in a state such that ventilation of the inside of the pipe is possible through the nylon mesh and the acrylic plate. Toyoura Standard Sand (available from Toyoura Keiseki Kogyo Co., Ltd.) was poured in the transparent pipe up to a height of 20 cm from the bottom plate. A high ammonia natural rubber latex was sprayed in an amount as shown in Table 1 (rubber content 60% by weight) using a paint sprayer ST6OH (manufactured by Asahipen Corporation) provided with a flexible nozzle onto the surface of the sand in the pipe. Further, an aqueous solution of citric acid with a concentration and amount shown in Table 1 was sprayed using a reciprocating sprayer (manufactured by Furupla Co., Ltd.) to evaluate the presence or absence of the water-retaining layer. Toyoura Standard Sand was further poured up to a height of 40 cm from the bottom plate, 1 liter of water was poured, and first day (immediately after the pouring), second day and seventh day water contents were measured. Incidentally, after the first day water content measurement, the pipe was allowed to stand at 23° C. at a humidity of 30%.

### Presence or Absence of Water-Retaining Layer

Immediately after spraying the aqueous solution of citric acid, presence or absence of the water-retaining layer was evaluated by touching the sand surface with a spatula or checking visually. When presence of the water-retaining layer was confirmed, it is shown by “yes”, and when the presence could not be confirmed, it is shown by “no”. The evaluation results are shown in Table 1.

### Thickness of Water-Retaining Layer

With respect to the case of “yes” in the evaluation of the water-retaining layer, the layer thickness was measured at a stage after completion of evaluation. The measurement results are shown in Table 1.

### Water Content

A pen-type soil moisture meter (pen-type soil moisture meter IP-65 of water-proof type manufactured by FUSO CO., LTD.) was inserted to a depth of 10 cm in the central part of the acrylic transparent pipe, to measure a water content in the sand. Incidentally, the “water content=(mass of water/mass of dry sand)×100”. In addition, the water content of 7th day to the water content of the first day was calculated as a “water retention ratio ((Water content of the seventh day/water content of the first day)×100)”. The results are shown in Table 1.

TABLE 1

| | Example | | | | Comparative Example | | | |
|---|---|---|---|---|---|---|---|---|
| | 1 | 2 | 3 | 4 | 1 | 2 | 3 | 4 |
| Spraying amount of high ammonia | 786 | 1180 | 1573 | 1573 | 1573 | 1573 | 1573 | — |
| natural rubber latex (g/m²) | | | | | | | | |
| Spraying amount of an | 629 | 629 | 629 | 629 | 629 | 315 | — | — |
| aqueous solution of citric acid | | | | | | | | |
| (g/m²) | | | | | | | | |
| (concentration of citric acid | (10) | (10) | (10) | (5) | (3) | (10) | — | — |
| (mass %) | | | | | | | | |
| Spraying amount ratio | 0.80 | 0.53 | 0.40 | 0.40 | 0.40 | 0.20 | — | — |
| (aqueous solution of citric | | | | | | | | |
| acid/latex) | | | | | | | | |
| Evaluation | | | | | | | | |
| Presence or absence of a | yes | yes | yes | yes | no | no | no | no |
| water-retaining layer | | | | | | | | |
| Thickness of a water-retaining | 0.6 | 0.9 | 1.1 | 2.1 | — | — | — | — |
| layer (mm) | | | | | | | | |
| Water content (%) | | | | | | | | |
| First day | 7.8 | 8.5 | 9.4 | 8.9 | 5.6 | 5.5 | 4.5 | 3.1 |
| Second day | 6.9 | 7.7 | 8.8 | 8.0 | 1.5 | 1.6 | 1.3 | 0.0 |
| Seventh day | 6.7 | 7.5 | 8.7 | 7.9 | 0.4 | 0.5 | 0.2 | 0.0 |
| Water retention ratio (%) | 86 | 88 | 93 | 89 | 7 | 9 | 4 | 0 |

From the results of Table 1, it can be seen that the water-retaining layer for retaining water in soil according to the present invention, which is composed of a coagulated natural rubber latex, shows a good water retention.

### INDUSTRIAL APPLICABILITY

The water-retaining layer for retaining water in soil according to the present invention, which is composed of a coagulated natural rubber latex, is good in water-retaining capability, is low in environmental load, and can be easily constructed. Therefore, water-retaining layer for retaining water in soil is useful in construction of a greening system, especially in remote areas such as a dry land.

1. A water-retaining layer for retaining water in soil, the water-retaining layer being composed of a coagulated natural rubber latex.

2. The water-retaining layer of claim 1, wherein the natural rubber latex is a high ammonia natural rubber latex.

3. The water-retaining layer of claim 1, wherein the coagulated natural rubber latex comprises a coagulant.

4. A greening system having the water-retaining layer of claim 1 provided underground in a depth of 3 to 300 cm from a surface of soil.

5. A construction method of the greening system of claim 4, comprising:
an exposing step of removing surface soil in a construction target land and exposing underground soil,
a spraying step of spraying a natural rubber latex on a surface of the exposed soil,
a coagulation step of coagulating the natural rubber latex to form a water-retaining layer, and
a covering step of covering the water-retaining layer with the removed surface soil.

6. A forming method for forming a water-retaining layer for retaining water in soil, the method comprising a step of spraying an un-coagulated natural rubber latex onto target soil and coagulating the un-coagulated natural rubber latex.

7. The forming method of claim 6, wherein a thickness of the water-retaining layer is 0.3 mm or more.

8. The forming method of claim 6, wherein an amount of natural rubber latex is 300 g/m² or more.

9. The forming method of claim 6, which is characterized in that the un-coagulated natural rubber latex is coagulated by spraying a coagulant.

10. The forming method of claim 9, wherein the coagulant is an organic acid.

11. The forming method of claim 9, wherein when the coagulant is dissolved or suspended in a solvent and is sprayed, a concentration of the coagulant is 4.0 to 30.0% by mass.

12. The forming method of claim 9, wherein an amount of a solution of the coagulant to an amount of natural rubber latex (amount of a solution of the coagulant/amount of natural rubber latex) is from 0.3 to 2.0.

13. A water-retaining layer for retaining water in spoil, which is formed by the forming method of claim 6.

14. A greening system having the water-retaining layer of claim 13 provided underground in a depth of 3 to 300 cm from a surface of soil.

15. A method of constructing a greening system, comprising a step of covering surface soil in a depth of 3 to 300 cm on the water-retaining layer formed by the forming method of claim 6.
